(19) United States
(12) Patent Application Publication
(10) Pub. No.: US 2025/0278612 A1
(43) Pub. Date: Sep. 4, 2025

(54) SYSTEMS AND METHODS FOR GENERATING NEW TRANSACTION FRAMEWORKS USING A MACHINE LEARNING MODEL

(71) Applicant: Wells Fargo Bank, N.A., San Francisco, CA (US)

(72) Inventors: Yvette Hatton, El Cerrito, CA (US); Nick Heim, San Francisco, CA (US); Peter T. Mulvey, San Francisco, CA (US); Justin Robert Wolf, San Francisco, CA (US)

(73) Assignee: Wells Fargo Bank, N.A., San Francisco, CA (US)

(21) Appl. No.: 18/593,751

(22) Filed: Mar. 1, 2024

(51) Int. Cl. G06N 3/0475; G06N 3/084; G06Q 20/06

(52) U.S. Cl. CPC G06N 3/0475; G06N 3/084; G06Q 20/06

(57) ABSTRACT

Systems and methods for generating new transaction frameworks using a machine learning model include a transaction framework training system and a transaction framework generation system. The transaction framework training system includes hardware configured to receive historical transaction framework data associated with a plurality of transaction frameworks corresponding to historical transactions performed by a provider. The historical transaction framework data includes final transaction framework terms and outcome data for each historical transaction. The hardware is configured to generate a machine learning model. The machine learning model is configured to generate new transaction frameworks. The machine learning model is generated using the historical transaction framework data. The transaction framework generation system includes hardware configured to receive input initial transaction framework data. The hardware is configured to generate an output transaction framework by applying the input initial transaction framework data to the machine learning model.

### TECHNICAL FIELD

The present disclosure relates to systems and methods for generating new transaction frameworks by training a machine learning model using historical transaction frameworks and generating new transaction frameworks using the trained machine learning model.

### BACKGROUND

Traditional business transaction structures often adhere to established models, which can inhibit innovation, stifle creative approaches to structuring agreements, and result in business transactions having relatively lower chances of succeeding.

### SUMMARY

An embodiment relates to a system. The system includes a transaction framework training system and a transaction framework generation system. The transaction framework training system includes hardware configured to receive historical transaction framework data associated with a plurality of transaction frameworks corresponding to historical transactions performed by a provider. The historical transaction framework data includes final transaction framework terms and outcome data for each historical transaction. The hardware is configured to generate a machine learning model. The machine learning model is configured to generate new transaction frameworks. The machine learning model is generated using the historical transaction framework data. The transaction framework generation system includes hardware configured to receive input initial transaction framework data. The hardware is configured to generate an output transaction framework by applying the input initial transaction framework data to the machine learning model.

Another embodiment relates to a method. The method includes receiving, by a transaction framework training system, historical transaction framework data associated with a plurality of transaction frameworks corresponding to historical transactions performed by a provider. The historical transaction framework data includes final transaction framework terms and outcome data for each historical transaction. The method includes generating, by the transaction framework training system, a machine learning model. The machine learning model is configured to generate new transaction frameworks. The machine learning model is generated using the historical transaction framework data. The method includes receiving, by a transaction framework generation system, input initial transaction framework data. The method includes generating, by the transaction framework generation system, an output transaction framework by applying the input initial transaction framework data to the machine learning model.

Another embodiment relates to a non-transitory computer readable medium storing instructions which, when executed by one or more processors, cause the one or more processors to receive historical transaction framework data associated with a plurality of transaction frameworks corresponding to historical transactions performed by a provider. The historical transaction framework data includes final transaction framework terms and outcome data for each historical transaction. The instructions further cause the one or more processors to generate a machine learning model. The machine learning model is configured to generate new transaction frameworks. The machine learning model is generated using the historical transaction framework data. The instructions further cause the one or more processors to receive input initial transaction framework data. The instructions further cause the one or more processors to generate an output transaction framework by applying the input initial transaction framework data to the machine learning model.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 depicts a block diagram of a computing environment including an artificial intelligence (AI) system, according to an example embodiment.

FIG. 2 depicts a block diagram of the AI system of FIG. 1, according to an example embodiment.

FIG. 3 depicts a block diagram of an AI model of the AI system of FIG. 1, according to an example embodiment.

FIG. 4 depicts a method of generating new transaction frameworks using the AI system of FIG. 1, according to an example embodiment.

FIG. 5 depicts a user interface for generating an output transaction framework, according to an example embodiment.

FIG. 6 depicts another user interface depicting a proposed output transaction framework, according to an example embodiment.

FIG. 7 depicts another user interface depicting benchmarking data, according to an example embodiment.

### DETAILED DESCRIPTION

Referring generally to the figures, systems and methods for generating new transaction frameworks (or new “deal” frameworks) using a machine learning model are disclosed. For example, systems and methods described herein allow for users to submit one or more terms related to a prospective transaction and receive a suggested framework with which to arrange the transaction which can differ from traditional business transaction structures, which often adhere to established models.

Beneficially, the machine learning model described herein enables the generation of a suggested framework based on a plurality of historic transaction frameworks. The machine learning model builds suggested frameworks using historical frameworks from a plurality of data sources (both internal and external to the provider), from beyond the frameworks already known to and used by the user, from frameworks involving a variety of industries, and so on. For example, in some instances, the machine learning model may be trained based on historic frameworks associated with another user at a provider using the system, frameworks that would be unknown to a user requesting a new transaction framework using systems and methods other than the machine learning model described herein. Accordingly, the systems and methods described herein allow for a user to receive relatively more creative and comprehensive new transaction frameworks relating to one or more terms associated with a prospective transaction, ultimately leading to an increase in the success of such business transactions.

The introduction of an AI system designed to generate innovative frameworks for business transactions represents a significant technical improvement to a pervasive challenge in deal-making. By leveraging advanced machine learning algorithms and data analytics, this system has the capability to break away from the constraints of traditional, often static frameworks. The AI system analyzes vast datasets, identifies patterns in historical transactions, and employs creative problem-solving approaches to propose novel structures that better align with the unique needs of specific transactions. This not only enhances the adaptability and responsiveness of transaction frameworks but also introduces a level of creativity and dynamism previously unattainable. In turn, the computer on which this AI system operates experiences marked improvement as it becomes a hub for groundbreaking advancements in transaction structuring. The efficiency gains, reduction in human error, and the ability to rapidly adapt to changing market conditions contribute to an overall enhancement of the computer system's capabilities, making it a more effective tool for facilitating complex business transactions in the evolving landscape of commerce.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

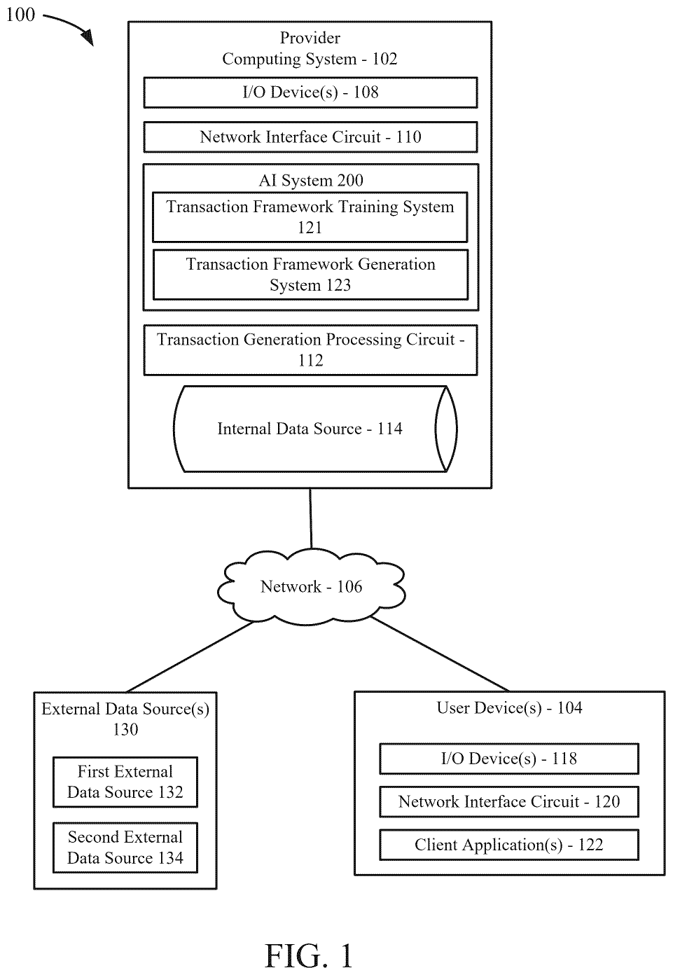

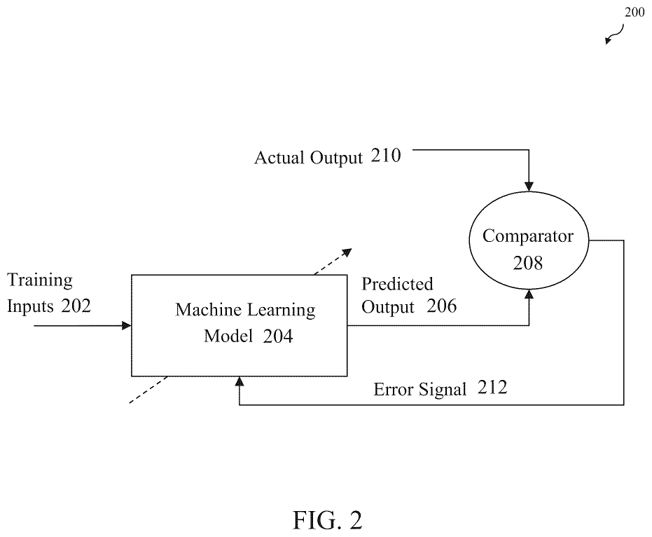

FIG. 1 is a diagram of a transaction generation system 100 for allowing users to receive new transaction frameworks generated by a machine learning model (e.g., machine learning model 204, as described in greater detail below with reference to FIG. 2), according to an example embodiment. As shown, the transaction generation system 100 includes a provider computing system 102 communicably coupled to one or more external data source(s) 130 and one or more user device(s) 104. The provider computing system 102 is owned by, associated with, or otherwise operated by a provider (e.g., a bank or other financial institution). The provider may maintain one or more accounts held by various customers, such as demand deposit accounts, credit card accounts, receivables accounts, and so on. The provider computing system 102, the one or more user devices 104, and the one or more external data source(s) 130 are in communication with each other and are connected by a network 106. In some embodiments, the AI system 200 is separate from the provider computing system 102, and may communicate with the provider computing system 102 via one or more networks, such as network 106.

In some instances, the provider computing system 102 may be embodied by one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 102 may include and/or have various other devices communicably coupled thereto, such as, for example, desktop or laptop computers (e.g., tablet computers), smartphones, wearable devices (e.g., smartwatches), and/or other suitable devices.

In some embodiments, the provider computing system 102 includes one or more I/O devices 108, a network interface circuit 110, an AI system 200, a transaction generation processing circuit 112, and an internal data source 114. The one or more I/O devices 108 are configured to receive inputs from and display information to a user. While the term “I/O” is used, it should be understood that the I/O devices 108 may be input-only devices, output-only devices, and/or a combination of input and output devices.

In some instances, the network interface circuit 110 includes, for example, program logic that connects the provider computing system 102 to the network 106. For example, in some instances, the program logic interfaces with one or more transceivers (e.g., Bluetooth, Wi-Fi, or any other suitable communication transceivers) to enable connection with the network 106. The network interface circuit 110 facilitates secure communications between the provider computing system 102, the external data source(s) 130, and each of the user device(s) 104. The network interface circuit 110 also facilitates communication with other entities, such as other banks or financial institutions, settlement systems, and so on. The network interface circuit 110 further includes user interface program logic configured to generate and present web pages to users accessing the provider computing system 102 over the network 106.

The transaction generation processing circuit 112 is structured to enable various functionalities described herein. For examples, in some instances, the transaction generation processing circuit 112 provides inputs to the AI system 200 and receives the output transaction framework generated by the AI system 200. The transaction generation processing circuit 112 can further process the output transaction framework and provide the output transaction framework to the user device 104 via the client application 122. The transaction generation processing circuit 112 is structured to further refine the output transaction framework (e.g., based on a user input received via the I/O device(s) 108, based on data received from the internal data source 114 or from an external data source 130, etc.) before providing the output transaction framework to the user via the user device 104.

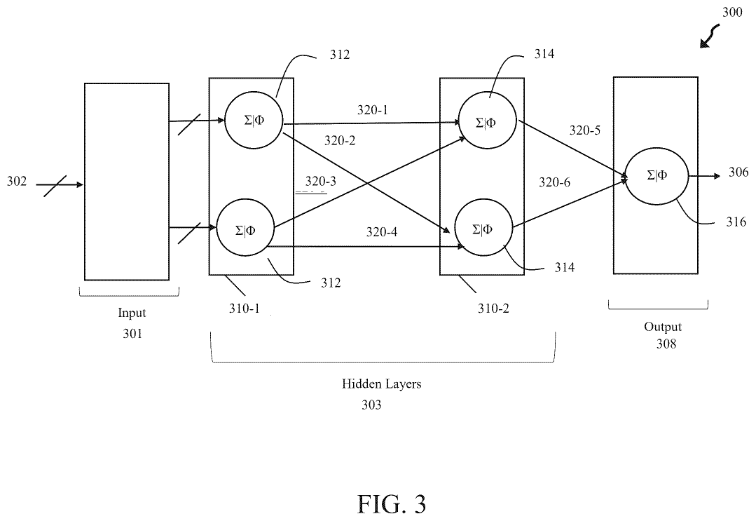

In some embodiments, the provider computing system 102 includes the AI system 200, as described below with reference to FIGS. 2 and 3. Alternatively, the AI system 200 may be remote to the provider computing system 102. As shown, the AI system 200 includes a transaction framework training system 121 and a transaction framework generation system 123. The AI system 200 may be configured to receive internal data stored by the provider computing system (e.g., from the internal data source 114). The provider computing system 102 may also be configured to retrieve data from the external data source(s) 130 to provide to the AI system 200 (e.g., as training inputs 202, as actual outputs 210, etc.). In some embodiments, the AI system 200 receives inputs from the user device(s) 104 via the provider computing system 102 (e.g., received by the network interface circuit 110).

In some embodiments, the internal data source 114 may include data relating to historical transactions performed by the provider (e.g., transaction documents, legal filings, patent filings, other relevant documents, etc.). For example, the internal data source 114 may include data relating to historical transactions such as equity financings (e.g., Initial Public Offerings, follow-on public offerings, private placements), debt financings (e.g., bond issuances, bank loans), hybrid financings (e.g., convertible bonds, preferred stock issuances), internal financings (e.g., retained earnings, sales of assets to generate funds), venture capital investments, private equity investments, government grants from specific government agencies for specific projects or initiatives, industry subsidies from industry-specific organizations, factoring (e.g., selling accounts receivables to third parties to access immediate funds), and invoice financing (e.g. using unpaid invoices as collateral to secure a loan or other funds).

The internal data source 114 may include, for one or more of the historical transactions performed by the provider, financial statements (e.g., income statements, balance sheets, and cash flow statements), revenue and sales data (e.g., detailed breakdowns of revenue sources, sales figures, sales growth rates, other data that offers insights into a company's market position and growth potential), profit margins (e.g., gross and net profit margins), earnings per share, information about a company's debt levels (e.g., debt levels, leverage ratios, interest coverage ratios), cash reserves and liquidity, liquidity ratios, short-term assets, information on planned or recent capital expenditures, market and industry comparisons (e.g., a comparison of the company's performance to industry benchmarks or competitors), information on potential risks the company faces or other challenges the company faces, management information (e.g., information regarding leadership of the company, operations, and future plans), future financial projections or guidance, corporate governance information (e.g., governance structure, information regarding the board of directors), legal and regulatory filings (e.g., Securities and Exchange Commission filings), and information regarding the negotiation and success of the transaction (e.g., draft proposed transaction data related to negotiations between parties, information on whether the transaction closed or fell apart, etc.). The provider computing system 102 may be communicably coupled to external data source(s) 130. The external data source(s) 130 may include at least one of a first external data source 132 or a second external data source 134.

In some embodiments, the first external data source 132 may include data (e.g., transaction documents, legal filings, patent filings, other relevant documents, etc.) relating to historical transactions performed by a different provider, such as another bank or financial institution different from the provider. The first external data source 132 can include the same types of information, or similar types of information, as the data stored in the internal data source 114, for different historical transactions (e.g., historical transactions performed by the different provider) or data for the same historical transactions in the case where the provider and the different provider are both involved in one or more same historical transactions.

In some embodiments, the second external data source 134 may include one or more third-party sources such as financial news sources (e.g., Bloomberg, Pitchbook, Cap.io, etc.), world news sources (e.g., New York Times, British Broadcasting Corporation, The Cable News Network, etc.), and social media (e.g., Facebook, YouTube, Instagram, etc.).

In some embodiments, the provider computing system 102 is communicably coupled to the external data source(s) 130 via one or more application programming interfaces (APIs). The provider computing system 102 obtains an API exposed by each external data source 130, which defines a set of endpoints and methods that the provider computing system 102 can utilize to obtained requested data. The provider computing system 102 initiates data retrieval from the external data source(s) 130 by causing HTTP requests, which specify the required parameters and operations, to be sent to the designated API endpoints associated with the external data source(s) 130. The one or more APIs process the requests by interacting with their respective databases or servers, and responds with structured data, often in JSON or XML format. The provider computing system 102 then parses and integrates the received data into a database or processing pipeline for storage or further analysis. For example, the provider computing system 102 can aggregate information received via APIs from multiple external data source(s) 130 before providing the aggregated information to the AI system 200.

The user device 104 is owned, operated, controlled, managed, and/or otherwise associated with a user, such as an employee of the provider (e.g., a banker, analyst, or other employee that works on business transaction “deals”), a client/customer of the provider (e.g., a person associated with an entity doing business with the provider), or a third party. In some embodiments, the user device 104 may be or may include, for example, a desktop or laptop computer (e.g. a tablet computer), a smartphone, a wearable device (e.g., a smartwatch), a personal digital assistant, and/or any other suitable computing device.

In some embodiments, the user device 104 includes one or more I/O devices 118, a network interface circuit 120, and one or more client applications 122. While the term “I/O” is used, it should be understood that the I/O devices 118 may be input-only devices, output-only devices, and/or a combination of input and output devices.

In some instances, the I/O devices 118 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen, etc.). In some instances, the I/O devices 118 further include one or more user interfaces (devices or components that interface with the user), which may include one or more biometric sensors (such as a fingerprint reader, a face scanner, an iris scanner, etc.).

The network interface circuit 120 includes, for example, program logic and various devices (e.g., transceivers, etc.) that connect the user device 104 to the network 106. For example, in some instances, the program logic interfaces with one or more transceivers (e.g., Bluetooth, Wi-Fi, or any other suitable communication transceivers) to enable connection with the network 106. The network interface circuit 120 facilitates secure communications between the user device 104 and the provider computing system 102. The network interface circuit 120 also facilitates communication with other entities, such as other banks, settlement systems, and so on.

In some embodiments, the user device 104 stores in computer memory, and executes (“runs”) using one or more processors, various client applications 122, such as an Internet browser presenting websites, text messaging applications, and/or applications provided or authorized by entities implementing or administering any of the computing systems in the transaction generation system 100.

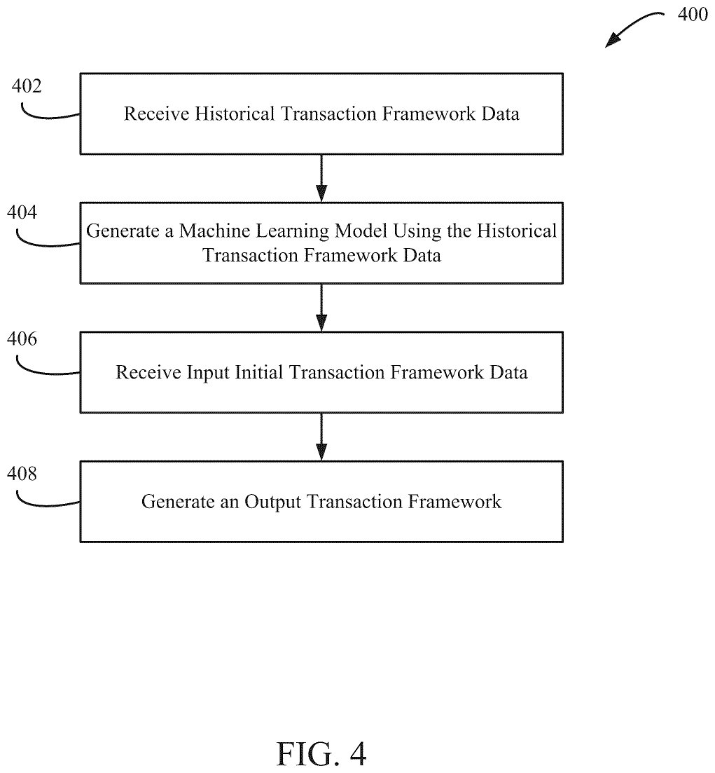

For example, in some instances, the client applications 122 include a provider client application (e.g., a financial institution banking application) provided by and at least partly supported by the provider computing system 102. For example, in some instances, the client application 122 coupled to the provider computing system 102 enables the user to perform various activities (e.g., review documents associated with the transaction, edit documents associated with the transaction, upload additional documents) associated with a transaction. In some instances, the client application 122 further prompts the AI system 200 to perform various functionalities described herein (e.g., with respect to FIG. 4) to generate, in response to a user input submitted via the client application 122, a new transaction framework.

Referring to FIG. 2, a block diagram of the AI system 200 is shown. In some embodiments, AI system 200 employs one or more of supervised learning, unsupervised learning, semi-supervised learning, reinforcement learning, self-supervised learning, transfer learning, deep learning, ensemble learning, instance-based learning, decision tree learning, batch learning, or online learning.

In some embodiments, AI system 200 employs supervised learning, which is a method of training a machine learning model given input-output pairs, where an input-output pair is an input with an associated known output (e.g., an expected output). In some embodiments, the AI system 200 employs unsupervised learning, which is a method of training a machine learning model where the model is presented with unlabeled data and must identify patterns or structures within it using techniques such as clustering or dimensionality reduction. In some embodiments, the AI system 200 employs semi-supervised learning, which is a method of training a machine learning model using a combination of supervised and unsupervised learning where the model is trained on a dataset with both labeled and unlabeled examples. In some embodiments, the AI system 200 employs reinforcement learning, method of training a machine learning model where an agents interacts with data and receives feedback in the form of rewards or penalties and the agent learns to take actions that maximize cumulative rewards over time. In some embodiments, the AI system 200 employs self-supervised learning, which is a method of training a machine learning model where the model generates its own labels from the input data. In some embodiments, the AI system 200 employs transfer learning, which is a method of training a machine learning model which involves training a model on one task and then leveraging the learned features for a different but related task. In some embodiments, the AI system 200 employs deep learning, which is a method of training a machine learning model involving neural networks with multiple layers. In some embodiments, the AI system 200 employs ensemble learning, which is a method of training a machine learning model which involves combining multiple models to improve overall performance and robustness, commonly using techniques such as bagging (e.g., Random Forests) and boosting (e.g., AdaBoost). In some embodiments, the AI system 200 employs instance-based learning, which is a method of training a machine learning model which involves making predictions based on similarities between new instances and instances in the training dataset, commonly using k-Nearest Neighbors (k-NN) algorithms. In some embodiments, the AI system 200 employs decision tree learning, which is a method of training a machine learning model which involves using a tree-like model of decisions and their possible consequences, where each node in the tree represents a decision based on input features. In some embodiments, the AI system 200 employs batch learning, which is a method of training a machine learning model where the model is trained on the entire dataset at once. In some embodiments, the AI system 200 employs online learning, which is a method of training a machine learning model where the model is updated continuously as new data arrives, allowing for real-time adaptation.

The machine learning model 204 may be trained based on general data and/or granular data (e.g., data based on a specific transaction or group of transactions) such that the machine learning model 204 may be trained specific to a particular industry (e.g., manufacturing, fintech, telemedicine, energy) or to a particular user (e.g., a user-employee of the provider). In some instances, the granular data refers to at least one of data from the internal data source 114 or external data source(s) 130.

The training inputs 202 and the actual outputs 210 may be provided to the machine learning model 204. The training inputs 202 may include historical transaction framework data. The historical transaction framework data may relate to a plurality of transaction frameworks corresponding to at least one of historical transactions performed by the provider via the internal data source 114 or other historical transactions via external data source(s) 130. The training inputs 202 may be transaction documents (e.g., lender presentations, investor presentations, requests for proposals, consummated transaction documents or presentations, etc.), legal filings, patent filings, documents evidencing market sentiment, any other publicly accessible documents, and so on.

The training inputs 202 and the actual outputs 210 may be received from one or more data sources. For example, the one or more data sources may include internal data source 114 and external data source(s) 130. Thus, the machine learning model 204 may be trained to generate new transaction frameworks based on the training inputs 202 and the actual outputs 210 used to train the machine learning model 204.

The AI system 200 may include one or more sub-systems. The one or more sub-systems may include a training system and a generation system. In an embodiment, the training system (e.g., transaction framework training system 121, as illustrated in FIG. 1) may be configured to generate a machine learning model (e.g., the machine learning model 204) trained on the training inputs 202. For example, using a supervised machine learning approach, the training system may use the historical framework data included in the training inputs 202 to predict outputs 206 (e.g., new transaction frameworks) by applying the current state of the training system to the training inputs 202. The comparator 208 may compare the predicted outputs 206 to actual outputs 210 to determine an amount of error or differences. For example, a predicted transaction framework (e.g., predicted output 206) generated based on the historical transaction framework data (e.g., the training inputs 202) may be compared to the plurality of transaction frameworks corresponding to the historical transaction framework data (e.g., actual output 210). The sub-systems may vary structurally based on the exact type of machine learning model(s) used by the AI system 200.

The generation system (e.g., transaction framework generation system 123) may be trained to make one or more recommendations to the user based on the predicted output (e.g., the predicted outputs 206) from the machine learning model 204. For example, the transaction framework generation system 123 may use the training inputs 202 (e.g., historical transaction framework data) to predict outputs 206 (e.g., new transaction frameworks) by applying the current state of the machine learning model 204 to the training inputs 202. In a supervised machine learning model, the comparator 208 may compare the predicted outputs 206 to actual outputs 210 to determine an amount of error or differences. The actual outputs 210 may be determined based on historic data of recommendations made to the user (e.g., output transaction frameworks previously generated by the generation system) or based on a comparison with historical transaction frameworks that were successful.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration, batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross-entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in a memory device or other data repository (e.g., a database) such that the machine learning model 204 may be employed on unknown data (e.g., not training inputs 202). Once trained and validated, the machine learning model 204 may be employed during a testing (or an inference phase). During testing, the machine learning model 204 may ingest unknown data to predict future data (e.g., new transaction frameworks for unprecedented transactions). It will be appreciated by one of ordinary skill in the art that the sub-systems of AI system 200 may differ with different machine learning model types.

Referring to FIG. 3, a block diagram of a simplified neural network model 300 is shown. The neural network model 300 may include a stack of distinct layers (vertically oriented) that transform a variable number of inputs 302 being ingested by an input layer 304, into an output 306 at the output layer 308.

The neural network model 300 may include a number of hidden layers 310 between the input layer 304 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306. Should a user of the transaction generation system 100 desire a different output, the user can adjust one or more weights to adjust the strength of particular nodes.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

With an example structure of the transaction generation system 100 being described above, example processes performable by the transaction generation system 100 (or components/systems thereof) are described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 4, a flow diagram of a method 400 for generating a new transaction framework using a machine learning model (e.g., the machine learning model 204) based on historical transaction framework data is shown, according to an example embodiment. In some instances, the method 400 is performed or otherwise executed using various components of the transaction generation system 100.

As shown, the method 400 begins with the AI system 200 receiving historical transaction framework data. The historical transaction framework data may be received by the transaction framework training system 121 from the provider computing system 102. The provider computing system 102 may retrieve the historical transaction framework data from the external data source(s) 130. In some embodiments, the historical transaction framework data may be the training inputs 202, as described above with reference to FIG. 2. The historical transaction framework data may be associated with a plurality of transaction frameworks corresponding to a plurality of historical transactions performed by the provider. In some embodiments, the historical transaction framework data may be associated with a plurality of transaction frameworks corresponding to a plurality of historical transactions performed by an external provider (e.g., a different provider other than the provider). In some embodiments, the historical transaction framework data may include initial transaction framework terms, one or more parties involved, final transaction framework terms, and outcome data for each of the plurality of historical transactions performed by the provider. For example, the one or more parties involved may include a proposing party (e.g., a business entity that is presenting a pitch) and a prospective lender.

The initial transaction framework terms may include one or more terms associated with a historical transaction that were initially presented by one of the one or more parties involved in the historical transaction. In some embodiments, the initial transaction framework terms may include at least one of a prospective collateral, a prospective timeline, an anticipated purpose, and a relevant industry. For example, the prospective collateral may refer to a monetary amount, a real estate property, a financial investment, or any other asset that the proposing party offers to the prospective lender as collateral against a loan. The prospective timeline may refer to a period of time over which the proposing offers to pay back the loan. The anticipated purpose may refer to one or more outcomes of the proposed transaction framework anticipated by the proposing party (e.g., one or more uses of a loan amount, one or more societal contributions, one or more returns on investment, a transfer of equity, etc.). The relevant industry may refer to a category of business transactions to which the new transaction framework relates (e.g., real estate development, business ventures within a given industry, capital investments for a particular industry, etc.).

The final transaction framework terms may include one or more terms associated with a historical transaction that are agreed upon by the one or more parties involved in the transaction. In some embodiments, the final transaction framework terms may include a negotiated collateral, a negotiated timeline, a realized purpose, and the relevant industry. For example, the negotiated collateral may refer to a monetary amount, a real estate property, a financial investment, or any other asset that the prospective lender and the proposing party agree to having as collateral against a loan. The negotiated timeline may refer to a period of time over which the proposing party pays back the loan. The realized purpose may refer to one or more realized outcomes of the transaction framework (e.g., one or more uses of a loan amount, one or more societal contributions, one or more returns on investment, etc.). In some embodiments, the proposing party may present an anticipated purpose regarding one use of a loan amount, but the realized purpose may indicate another use of the loan amount. For example, the proposing party may anticipate using the loan amount to fund a capital investment (e.g., new machinery), but the prospective lender may negotiate that the proposing party also use the loan amount to increase employee wages. Therefore, the realized purpose may be the capital investment and the increase in employee wages, while the anticipated purpose was the capital investment alone.

The outcome data may include an indication of whether each of the historical transactions associated with the historical transaction framework data led to a transaction closing or led to abandonment of the historical transaction. For example, the historical transactions that led to a transaction may be labeled with an outcome of “success,” while the historical transactions that ended in abandonment may be labeled with an outcome of “failure.” The outcome data may further include an indication of a discrepancy between the initial transaction framework terms and the final transaction framework terms associated with each of the historical transactions. For example, the indication of the discrepancy may include a percentage, a ratio, a fraction, or other metric. The discrepancy between the initial transaction framework terms and the final transaction framework terms may indicate how much negotiation occurred between the initial transaction proposal and the agreement upon the final transaction framework terms. For example, a 15% discrepancy may indicate that 15% of the terms proposed by the proposing party in the initial transaction proposal were changed during negotiations with the prospective lender before reaching the final transaction framework terms.

Upon receiving the historical framework data, at step 402, the AI system 200 generates a machine learning model, at step 404. In some embodiments, the machine leaning model may be the machine learning model 204, as described above, with reference to FIG. 2. The machine learning model may be configured to generate new transaction frameworks. In some embodiments, the machine learning model may be generated based on the historical transaction framework data. The machine learning model may be generated by the transaction framework training system 121, as described above, with reference to FIG. 2.

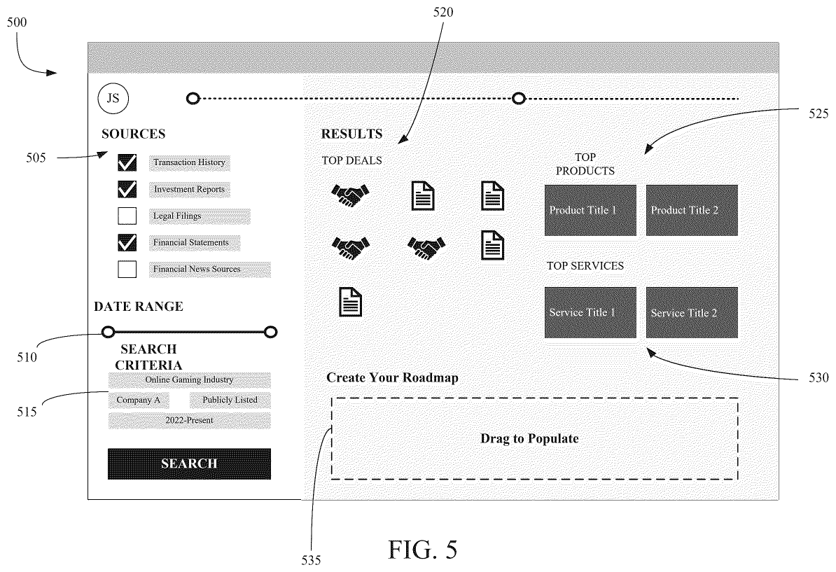

Upon generating the machine learning model, at step 404, the AI system 200 may be configured to receive input initial transaction framework data, at step 406. In some embodiments, the transaction framework generation system 123 receives the input initial transaction framework data from a user via the user device(s) 104. The user may indicate the initial transaction framework data by interacting with an interface generated by the client application(s) 122, as described below, with reference to FIG. 5. The input initial transaction framework data may include at least one of the prospective collateral, the prospective timeline, the anticipated purpose, and the relevant industry associated with the transaction for which the user is requesting the new transaction framework.

Upon receiving the initial transaction framework data, at step 406, the AI system 200 may be configured to generate an output transaction framework. In some embodiments, the transaction framework generation system 123 generates the output transaction framework by applying the input initial transaction framework data to the machine learning model generated at step 404. The machine learning model may be configured to pair at least one of the input initial transaction framework data with at least one of the initial transaction framework terms and the final transaction framework terms. For example, to generate the output transaction framework based on the input initial transaction framework data, the machine learning model may identify at least one of the prospective collateral, the prospective timeline, the anticipated purpose, and the relevant industry common to the input initial transaction framework data and to at least one of the initial transaction framework terms and the final transaction framework terms associated with the historical transaction framework data. For example, the machine learning model may identify historical transaction framework data relating to the one or more uses of a loan amount indicated by the input initial transaction framework data and may generate the output transaction framework using that historical transaction framework data. The machine learning model will then generate the output transaction framework based on the historical transaction framework data that includes the paired data. In some embodiments, the machine learning model is further configured to identify the historical transaction framework data that includes the paired data and that indicates a “success” outcome. For example, after identifying the historical transaction framework data relating to the one or more uses of the loan amount, the machine learning model may further narrow down that data to include only transaction frameworks relating to the one or more uses of the loan amount and that led to a successful outcome.

After generating the output transaction framework, the transaction framework generation system 123 may transmit the output transaction framework to the user device(s) 104 from which the provider computing system 102 received the input initial transaction framework data. For example, the output transaction framework may be represented by user interface 500, as described below.

Referring to FIG. 5, a user interface 500 is shown for generating an output transaction framework, according to an example embodiment. In some instances, the user interface 500 is generated by the provider computing system 102 and is provided to the user device 104 via the client application 122. In some embodiments, the user interface 500 may include a new transaction framework generated by the machine learning model 204 in response to a transaction framework request including one or more user inputs. As illustrated, the user interface 500 includes one or more sources 505, a date range 510, a search criteria 515, one or more results 520, one or more products 525, one or more services 530, and a roadmap field 535.

The one or more sources 505 may be selectable elements representing one or more data sources (e.g., external data source(s) 130) from which the machine learning model retrieves data to use in generating the new transaction framework for the user. For example, the one or more sources 505 may represent internal data source 114 and one or more external data source(s) 130. By engaging with the selectable elements, the user can designate which data sources should be used in generating the new transaction framework. For example, this may be advantageous if the user wishes to limit new transaction frameworks to only resemble transactions that have already been executed by the provider (e.g., selecting only internal data sources out of the plurality of available data sources 505).

The date range 510 refers to a time period over which the machine learning model uses data to generate the new transaction framework for the user. In some embodiments, the date range 510 may be represented by a slidable toggle configured to allow the user to select a lower boundary of the time period and an upper boundary of the time period. For example, a lower extreme on the slidable toggle may be a date corresponding to an earliest transaction stored in the internal data source 132. An upper extreme on the slidable toggle may be a date when the user accesses the machine learning model (e.g., today). By engaging with the slidable toggle representing the date range 510, the user can instruct the machine learning model to only base an output transaction framework on data according to the date range 510. For example, this may be advantageous if the user prefers a new transaction framework based on transaction frameworks that have occurred in a certain time period (e.g., the past year, the past 5 years, this decade, etc.).

The search criteria 515 refers to an input field where the user can designate additional inputs relating to a request for a new transaction framework. For example, the additional inputs available in the search criteria 515 may include a prospective collateral, a relevant industry, an entity type of the one or more parties involved, etc. In some embodiments, the search criteria 515 includes a free-text box, one or more selectable elements, a drop-down menu of options, and so on. By engaging with the search criteria 515, the user can further narrow down the data used by the machine learning model in generating the new transaction framework so that the results align with the transaction for which the user is requesting the new transaction framework.

The one or more results 520 may be one or more previous transactions identified by the machine learning model as including one or more relevant framework components for the new transaction framework requested by the user. In some embodiments, documents may be represented by a first selectable element (e.g., a document icon), while other pitch materials (e.g., calls, email correspondences, presentations, etc.) may be represented by a second selectable element (e.g., a handshake icon). By engaging with the first selectable element and/or the second selectable element via the user interface 500, the user may be prompted to view the materials (e.g., documents, calls, presentations, email correspondences, etc.) associated with the one or more previous transactions. In some embodiments, the one or more results 520 may identify “top” business transactions relevant to the search criteria 515 entered by the user for comparison to the output transaction framework generated by the AI system 200.

The one or more products 525 refers to one or more product offerings identified among the historical transaction framework data that relates to the input initial transaction framework data submitted by the user. In some embodiments, the one or more products 525 may be one or more products included in transactions that resulted in a successful outcome. For example, the one or more products 525 may include a public lender presentation or any other type of pitch offered by the proposing party. In some embodiments, the one or more products 525 may include a shell of a document retrieved from the historical transaction framework data. For example, the one or more products 525 may be a shell for a refinancing institutional term loan for an energy transaction. In this example, the shell may include information relating to the type of product, the relevant industry, technical data, or any other contextual information that may be common among refinancing institutional term loans for the energy transaction.

The one or more services 530 refers to one or more service offerings identified among the historical transaction framework data that relates to the input initial transaction framework data submitted by the user. In some embodiments, the one or more services 530 may be one or more services included in transactions that resulted in a successful outcome. For example, the one or more services 530 may include a loan package, a mortgage plan, or any other service offered by a financial institution.

The roadmap field 535 provides an input area of the user interface 500 into which the user can drag at least one of the one or more results 520, the one or more products 525, and the one or more services 530. The roadmap field 535 may be configured to, upon receiving an indication that the user has dragged at least one of the one or more results 520, the one or more products 525, and the one or more services 530 into the input area, combine each of the elements dragged by the user to create the new transaction framework. For example, the user may drag a shell of a public lender presentation from the one or more products 525 and a loan package from the one or more services 530 to construct a new transaction framework based on the initial input transaction framework data that includes the shell of the public lender presentation and the loan package.

In some embodiments, the transaction generation processing circuit 112 may arrange the options available for results 520, products 525, and services 530 based on the selected sources 505, date range 510, and search criteria 515, such that recommended selections for results 520, products 525, and services 530 are displayed more prominently than the other options. For example, in some instances, the recommend options may be bolded, underlined, enlarged, or moved to an uppermost location (i.e., the first choice) from among the options available for results 520, products 525, and services 530. In some instances, upon determining that the recommended results 520, products 525, and services 530 has changed due to the user changing the selected sources 505, date range 510, and search criteria 515, the transaction generation processing circuit 112 is configured to modify or update the graphical user interface 500 to rearrange or redesign the results 520, products 525, and services 530 selectable elements such that the new recommended options are prominently displayed instead of the previous recommended options.

Furthermore, in some instances, the selected sources 505, date range 510, search criteria 515, results 520, products 525, and services 530 options shown within the graphical user interface 500 may be arranged based on their estimated relevance to the user. For example, in some instances, the transaction generation processing circuit 112 is configured to estimate the most relevant and/or useful options for inclusion in the user interface 500 using one or more machine learning models. In some instances, the transaction generation processing circuit 112 may train the one or more machine learning models to identify the most relevant and/or useful options for inclusion using various training data. The training data may comprise historical utilization of similar options or preferences of users or clients/customers. In some instances, the training data may be data compiled over time from a variety of users associated with the provider and stored within a database associated with the provider computing system 102.

Accordingly, once the one or more machine learning models have been trained, the transaction generation processing circuit 112 may apply the sources 505, date range 510, search criteria 515, results 520, products 525, and services 530 options to the one or more machine learning models to identify the most relevant and/or useful options for inclusion on the graphical user interface 500. The transaction generation processing circuit 112 may further arrange the options available specifically according to their estimated relevance. For example, in some instances, the most relevant features may be arranged in a top left corner of the screen. The features may then be arranged in descending order of relevance from left to right and top to bottom within the graphical user interface. In some instances, the transaction generation processing circuit 112 is configured to utilize various feedback information (e.g., options actually used by the user or clients/customers) received from the user (e.g., via the user device 104) to retrain or otherwise update the one or more machine learning models. Accordingly, in some instances, the transaction generation processing circuit 112 may rearranged the options on the graphical user interface 500 based on the updated machine learning models and their associated outputs.

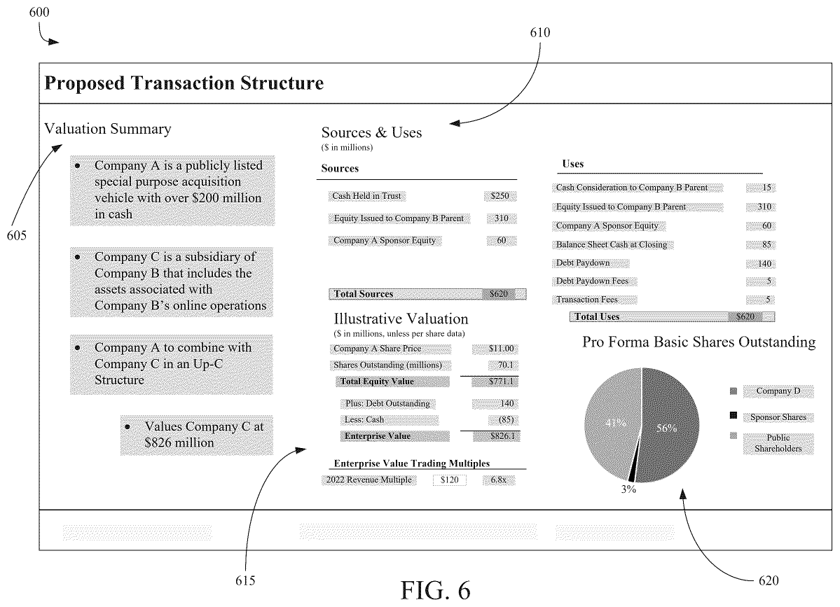

Referring to FIG. 6, a user interface 600 is shown depicting a proposed output transaction framework, according to an example embodiment. In some instances, the user interface 600 is generated by the provider computing system 102 and provided to the user device 104 via the client application 122. In some embodiments, the user interface 600 may include a proposed transaction structure (e.g., a new transaction framework) generated by the machine learning model. As illustrated, the user interface 600 includes a valuation summary 605, sources and uses data 610, an illustrative valuation 615, and outstanding shares data 620.

The valuation summary 605 refers to an assessment of the value of the one or more entities involved in the transaction. For example, if the transaction framework relates to a merger or acquisition, the valuation summary 605 may reflect the value of the company, business, enterprise, etc., involved in the transaction. In some embodiments, the valuation summary 605 may include one or more subsections. The one or more subsections may include data such as any assets owned by the one or more entities, subsidiaries of the one or more entities, and so on. In some embodiments, the output transaction framework includes proposals for restructuring a company as part of the transaction (e.g., Company A to combine with Company C in an Up-C Structure).

The sources and uses data 610 refers to one or more sources of monetary funds, with their associated amounts, and one or more uses for the monetary funds. For example, the one or more sources may include an amount of cash held in a trust fund account, an amount of equity issued to a parent company, an amount of equity from a sponsor company, and so on. The one or more uses may include a cash consideration to the parent company, an amount of equity issued to the parent company, an amount of equity from a sponsor company, an amount of cash from a balance sheet at closing, a debt paydown, one or more debt paydown fees, transaction fees, and so on.

The illustrative valuation 615 refers to data relating to the equity and the enterprise value of the one or more entities. For example, the illustrative valuation may include a total equity value and a pro forma enterprise value. In some embodiments, the total equity value may include a sponsor company share price, an amount in pro forma shares outstanding, etc. The pro forma enterprise value may include the total equity value, plus an amount of debt outstanding, less an amount of cash. The illustrative valuation 615 may further include an enterprise value trading multiple.

The outstanding shares data 620 refers to a graphical representation of pro forma basic shares outstanding. In some embodiments, the graphical representation of the pro forma basic shares may include a pie chart, a bar graph, a line graph, a scatterplot, etc. As shown in FIG. 6, the pie chart may include one or more owners of the shares and a percentage of the shares owned by the owner. For example, the owner of the shares may include an external company, a sponsor company, public shareholders, etc.

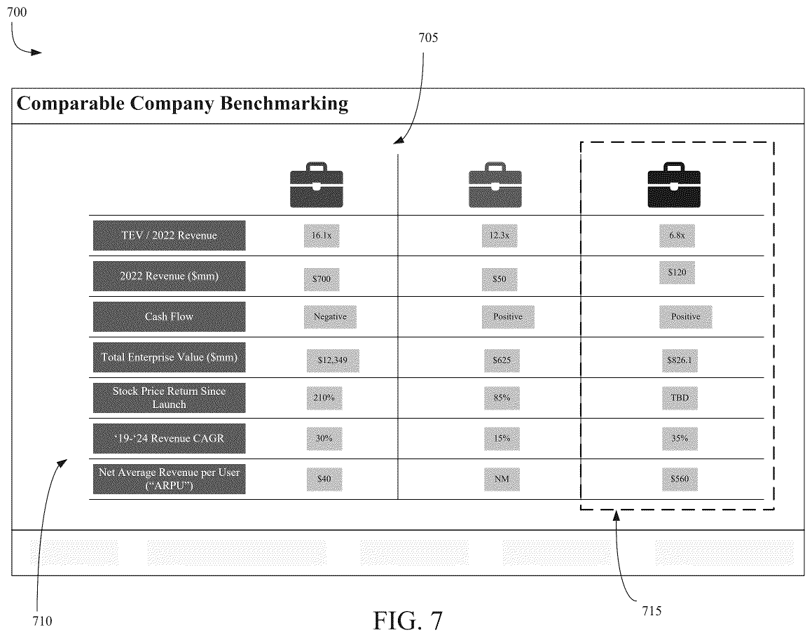

Referring to FIG. 7, a user interface 700 is shown depicting benchmarking data, according to an example embodiment. In some instances, the user interface 700 is generated by the provider computing system 102 and provided to the user device 104 via the client application 122. In some embodiments, the user interface 700 may include a comparable company benchmarking data generated by the machine learning model 204 in response to a new transaction framework. The comparable company benchmarking data may relate to one or more comparable companies in the same relevant industry as the transaction framework. In some embodiments, user interface 700 may compare the data of the one or more comparable companies to that of a company associated with the new transaction framework. As illustrated, the user interface 700 includes the one or more comparable companies 705, one or more performance metrics 710, and the company associated with the new transaction framework 715.

In some embodiments, the one or more performance metrics 710 may include a total enterprise value (TEV)/Revenue valuation multiple, an amount of revenue from a previous fiscal year, a cash flow evaluation (e.g., a positive cash flow, a negative cash flow), a total enterprise value, a stock price return since launch, a compounded annual growth rate (CAGR) revenue over a specific timeframe (e.g., 5 years, 10 years, 20 years, etc.), a net average revenue per user (ARPU), and so on. By including these one or more performance metrics 710 associated with the one or more comparable companies 705 and with the company associated with the new transaction framework 715, the proposing party of the new transaction framework can demonstrate to the prospective lender that the present transaction includes promising performance and outcomes within the relevant industry.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A system comprising:
a transaction framework training system comprising hardware configured to:
receive historical transaction framework data associated with a plurality of transaction frameworks corresponding to historical transactions performed by a provider, the historical transaction framework data comprising final transaction framework terms and outcome data for each historical transaction;
generate a machine learning model configured to generate new transaction frameworks, the machine learning model generated using the historical transaction framework data; and
a transaction framework generation system comprising hardware configured to:
receive input initial transaction framework data; and
generate an output transaction framework by applying the input initial transaction framework data to the machine leaning model.

2. The system of claim 1, wherein the historical transaction framework data further comprises initial transaction framework terms.

3. The system of claim 2, wherein the initial transaction framework terms further comprise at least one of a prospective collateral, a prospective timeline, an anticipated purpose, and a relevant industry.

4. The system of claim 1, wherein the historical transaction framework data further comprises one or more parties involved in the historical transactions.

5. The system of claim 1, wherein the historical transaction framework data is retrieved from at least one of an internal data source or an external data source.

6. The system of claim 1, wherein the outcome data for each historical transaction further comprises one of either a successful outcome or a failed outcome.

7. The system of claim 1, wherein the final transaction framework terms further comprise at least one of a negotiated collateral, a negotiated timeline, a realized purpose, and a relevant industry.

8. The system of claim 1, wherein the input initial transaction framework data is received from a user via a user device.

9. The system of claim 8, wherein the transaction framework generation system is further configured to transmit the output transaction framework to the user via a user interface of the user device, the output transaction framework further comprising one or more output transaction framework terms.

10. The system of claim 9, wherein the user interface comprises one or more selectable elements configured to allow the user to change at least one of the one or more output transaction framework terms associated with the output transaction framework.

11. A method comprising:
receiving, by a transaction framework training system, historical transaction framework data associated with a plurality of transaction frameworks corresponding to historical transactions performed by a provider, the historical transaction framework data comprising final transaction framework terms and outcome data for each historical transaction;
generating, by the transaction framework training system, a machine learning model configured to generate new transaction frameworks, the machine learning model generated using the historical transaction framework data;
receiving, by a transaction framework generation system, input initial transaction framework data; and
generating, by the transaction framework generation system, an output transaction framework by applying the input initial transaction framework data to the machine learning model.

12. The method of claim 11, wherein the historical transaction framework data further comprises initial transaction framework terms, the initial transaction framework terms further comprising at least one of a prospective collateral, a prospective timeline, an anticipated purpose, and a relevant industry.

13. The method of claim 11, wherein the historical transaction framework data further comprises one or more parties involved in the historical transactions.

14. The method of claim 11, wherein the historical transaction framework data is retrieved from at least one of an internal data source or an external data source.

15. The method of claim 11, wherein the outcome data for each historical transaction further comprises one of either a successful outcome or a failed outcome.

16. The method of claim 11, wherein the final transaction framework terms further comprise a negotiated collateral, a negotiated timeline, a realized purpose, and a relevant industry.

17. The method of claim 11, wherein the input initial transaction framework data is received from a user via a user device.

18. The method of claim 17, further comprising transmitting, by the transaction framework generation system, the output transaction framework to the user via a user interface of the user device, the output transaction framework further comprising one or more output transaction framework terms.

19. The method of claim 18, wherein the user interface comprises one or more selectable elements allowing the user to change at least one of the one or more output transaction framework terms associated with the output transaction framework.

20. A non-transitory computer readable medium storing instructions which, when executed by one or more processors, cause the one or more processors to:
receive historical transaction framework data associated with a plurality of transaction frameworks corresponding to historical transactions performed by a provider, the historical transaction framework data comprising final transaction framework terms and outcome data for each historical transaction;
generate a machine learning model configured to generate new transaction frameworks, the machine learning model generated using the historical transaction framework data;
receive input initial transaction framework data; and
generate an output transaction framework by applying the input initial transaction framework data to the machine learning model.
